(19) United States
(12) Patent Application Publication
(10) Pub. No.: US 2014/0074588 A1
(43) Pub. Date: Mar. 13, 2014

(54) DETERMINING CONTENT ITEM ENGAGEMENT

(71) Applicants: Fred Bertsch, Belmont, CA (US); James Beser, Burlingame, CA (US); David Monsees, San Francisco, CA (US)

(72) Inventors: Fred Bertsch, Belmont, CA (US); James Beser, Burlingame, CA (US); David Monsees, San Francisco, CA (US)

(73) Assignee: GOOGLE INC., Mountain View, CA (US)

(21) Appl. No.: 13/607,908

(22) Filed: Sep. 10, 2012

(51) Int. Cl. G06Q 30/02

(52) U.S. Cl. 705/14.42

(57) ABSTRACT

Methods, and systems, including computer programs encoded on computer-readable storage mediums, including a method for determining an aggregated user exposure level to a content item. The method includes receiving, by a user device, a content item; accessing, by the user device, measurement instructions including instructions to measure user exposure levels to the content item during various display states, and upon execution of the measurement instructions by the user device: detecting, by the user device, at least two display states; for each of the display states, determining, by the user device, a user exposure level of the content item in the viewport for the display state, the user exposure level being a measurement of (i) an area of the particular portion of the viewport occupied by the content item and (ii) a duration of the display state; and determining, by the user device, an aggregation of the user exposure levels.

### BACKGROUND

This specification generally relates to advertising.

For some content item delivery services, content sponsors are charged when their content items are placed on a resource rendered on a user device. Such a placement is generally referred to an impression of the content item. For example, when an advertiser's advertisement is placed on a web page displayed on a user device, the content item delivery service charges the advertiser for an impression of the advertisement.

### SUMMARY

In general, one aspect of the subject matter described in this specification can be implemented in methods that include receiving, by a user device, a content item from a content item provider. Accessing, by the user device, measurement instructions from the content provider including instructions to measure user exposure levels to the content item during various display states of a viewport of the user device. Each of the display states represents a particular portion of the viewport occupied by at least a portion of the content item where the particular portion of each display state is different from the particular portion of each other display state. Upon execution of the measurement instructions by the user device, detecting, by the user device, at least two display states. For each of the display states, determining, by the user device, a user exposure level of the content item in the viewport for the display state. The user exposure level is a measurement of (i) an area of the particular portion of the viewport occupied by the at least a portion of the content item for the display state and (ii) a duration of the display state. Determining, by the user device, an aggregation of the user exposure levels of the display states.

Other embodiments of this aspect include corresponding systems, apparatus, and computer programs, configured to perform the actions of the methods, encoded on computer storage devices.

These and other embodiments can each optionally include one or more of the following features. The method can include determining, by the user device, that the aggregation satisfies a user exposure level threshold; and providing, by the user device, an indication to the content item provider that the aggregation satisfies the user exposure level threshold. The method can also include determining, by the user device, that the area of the particular portion of the viewport occupied by the at least a portion of the content item satisfies a viewport area threshold.

The method can include determining the user exposure level only in response to determining that the area of the particular portion of the viewport occupied by the at least a portion of the content item satisfies the viewport area threshold. The method can include determining a product of the area of the particular portion of the viewport occupied by the at least a portion of the content item in the display state and the duration of the display state and determining a sum of the products.

The method can include requesting the measurement instructions from a server apparatus hosted by the content provider and providing the user exposure levels to the content item provider. The user exposure level threshold can be specified by a sponsor of the content item.

Particular implementations of the subject matter described in this specification can be implemented to realize one or more or none of the following advantages. A content item sponsor is only charged for an impression of a content item if the measured user engagement/exposure to the content item satisfies an exposure threshold. Thus the content item sponsor only pays for impressions that have a minimum user exposure level set by the exposure threshold. For example, the exposure threshold can be that at least fifty percent of the viewport is occupied by the content item for at least five seconds. This ensures that content item sponsors only pay for impressions of content items for which exposures to users meet some minimum requirement (a “qualifying impression”), which increases the value of the impressions to the content sponsors.

By way of an example, an advertisement may be placed on a web page rendered by a mobile user device. However, given the limited viewport size of the mobile device the advertisement may be placed on a portion of the web page that is not displayed in the viewport and, as such, not visible to a user or only a small fraction of the advertisement is momentarily displayed in the viewport as the user pans around the web page. Thus an impression has likely occurred even though the advertisement may not be exposed to the user at all or is only fleetingly exposed to the user. Measuring user engagement to the advertisement and setting a minimum exposure or engagement level can ensure the advertiser is not charged for such an impression (or any other impression that is not a qualifying impression), which may not bring the benefit expected by the advertiser such as increased brand awareness or sales.

The exposure of the user to a content item can be measured across different viewport display states. Each display state represents a particular portion of the viewport occupied by at least a portion of the content item. The exposure level of the content item at each display state can be aggregated (e.g., aggregate a first display state in which fifty percent of the viewport is occupied by the content item for five seconds and a second display state in which eighty percent is occupied, after a zoom, for three seconds). This aggregated exposure level can be compared to an exposure threshold to determine if the aggregated exposure level satisfies the threshold and, hence, the impression is a qualifying impression.

Aggregating user exposure levels across different display states provides a more comprehensive view of the user's exposure to the content item during a resource view event than does only analyzing exposure levels on a per display state basis. This allows the advertiser to determine that a qualifying impression occurred during a resource view event, and recognize the value associated therewith, even though on a per display state basis no qualifying impression occurred.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example environment for delivering content.

FIG. 2A is a flow diagram of an example process for determining user exposure levels to content items.

FIGS. 2B-2D are screen shots of an example resource displayed in a viewport having first, second and third display states, respectively.

FIG. 3 is a flow diagram of an example process for receiving an indication that a user exposure level to content item satisfies a threshold.

FIG. 4 is a block diagram of a programmable processing system.

Like reference symbols in the various drawings indicate like elements.

### DETAILED DESCRIPTION

For some user devices, such as smartphones, a content item (e.g., advertisement) placed on a resource (e.g., web page) may not be initially visible to a user of the device because the content item is rendered on a portion of the resource that is not in the device's viewport. For example, because of the zoom level of the viewport (e.g., the viewport is zoomed-in), the size of the viewport and/or the dimensions of the resource, not all of the resource's contents are displayed in the viewport at the same time upon rendering. Other resources, however, may be displayed in a viewport in such a way (e.g., the viewport is zoomed-out) that permits all of the resource's content to be displayed in the viewport. However, typically, at such zoom levels the contents of the resource are illegible or difficult to discern, including any content items. Further, even if the content item is displayed in the viewport in a form that is readily appreciable by a user, it may only be so momentarily as the user pans around the resource to display other resource content in the viewport.

Regardless of whether a content item is actually displayed or to what extent, a content sponsor may nonetheless be charged for an impression, as the determination of whether an impression (as opposed to a qualifying impression) occurred is based on whether or not the content item was placed on a rendered resource. Thus even though the user had minimal, if any, exposure to the content item and the content sponsor likely did not receive the value expected from the impression, the content sponsor is charged for the impression. As described below, user exposure levels can be determined and used as a proxy to measure user engagement to content items to address such issues.

More particularly, in some implementations, publisher instructions (e.g., a script) in a resource being rendered by a user device cause the user device to request a content item from a content item provider for placement/display on the resource and to access measurement instructions from the content item provider.

The measurement instructions, upon execution by the user device, cause the user device to measure the exposure level(s) of a user of the user device to the content item during various display states. Each display state represents a different portion of the viewport occupied by the content item at various times during a viewing event of the resource. For example, a first display state represents that three square centimeters of the area of the viewport is occupied by the content item during a first time period during the resource viewing event and a second display state represents that five square centimeters of the area of the viewport is occupied by the content item (e.g., after the user device zooms in on the content item) during a second time period during the resource viewing event.

In accord with the measurement instructions, the user device determines the user exposure levels to the content item for multiple different display states of the user device's viewport. The user exposure level for a particular display state is a measure of (i) an area of the portion of the viewport occupied by the content item for the display state (e.g., X square centimeters) and (ii) a duration of the display state (e.g., how long the viewport was in the display state). An exposure level is measured for each display state. The measurement instructions cause the user device to aggregate the user exposure levels for multiple display states to the content item and to determine whether the aggregate exposure level satisfies a threshold. If the aggregate exposure level satisfies the threshold, the measurement instructions cause the user device to notify the content item provider accordingly (e.g., indicate a qualifying impression occurred) or provide the display state data to the content item provider for processing.

By way of an example, a content item is displayed in a first display state for four seconds and a second display state for two seconds. The first display state represents the content item occupying three square centimeters of the viewport and the second display state represents the content item occupying five square centimeters of the viewport. The user device, upon execution of the measurement instructions, determines that the user exposure level for the first display state is twelve centimeter squared-seconds (4 seconds*3 cm²) and the user exposure level for the second display state is ten centimeter squared-seconds (2 seconds*5 cm²). Thus the aggregate user exposure level for the first and second display states during the resource viewing event is twenty-two centimeter squared-seconds. If the threshold is twenty centimeter squared-seconds, then the measurement instructions cause the user device to send an indication to the content item provider that a qualifying impression occurred. The determination and aggregation of user exposure levels are further described below.

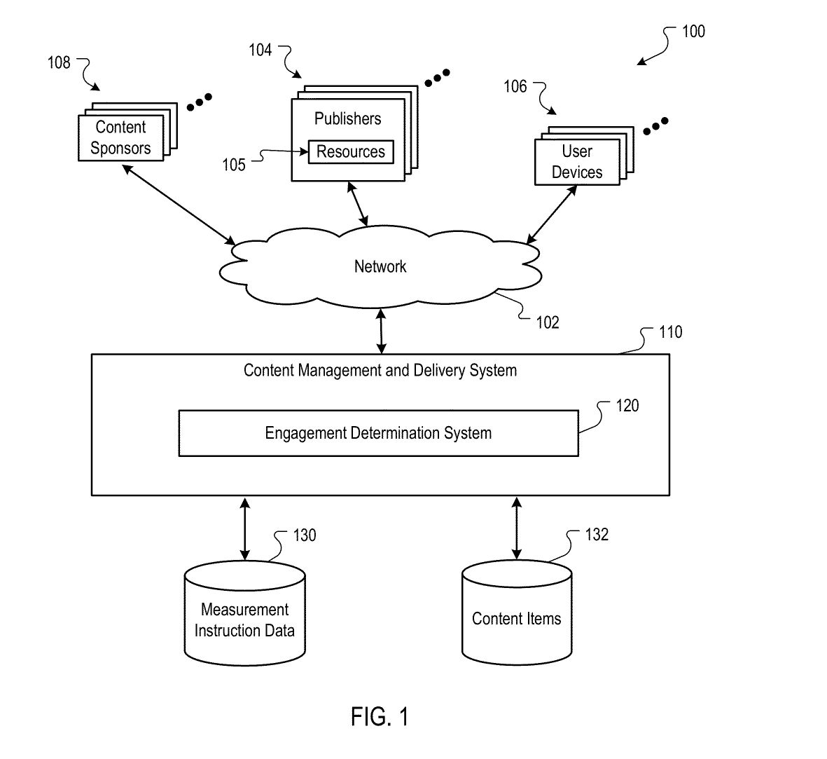

FIG. 1 is a block diagram of an example environment 100 for delivering content. The example environment 100 includes a content management and delivery system 110 for selecting and providing content to user devices 106. The example environment 100 also includes a network 102, such as wide area network (WAN), the Internet, or a combination thereof. The network 102 connects publishers 104, user devices 106, content sponsors 108 (e.g., advertisers) and the engagement determination system 120 (which may be part of or separate from the content management and delivery system 110). The example environment 100 may include numerous publishers 104, user devices 106, and content sponsors 108.

A resource 105 can be any data that can be provided over the network 102. A resource 105 can be identified by a resource address (e.g., uniform resource locator, “URL”) that is associated with the resource 105. Resources 105 include HTML pages, word processing documents, portable document format (PDF) documents, images, video, and news feed sources, to name only a few. The resources 105 can include content, such as words, phrases, images, video and sounds, that may include embedded information (such as meta-information hyperlinks) and/or embedded instructions (such as scripts).

In some implementations, the resources 105 can include sponsored content provided by the content sponsors 108 that can be rendered in specific locations (e.g., advertisement slots) in the resource 105. For example, the resources 105 can include an advertisement sponsored by a content sponsor 108. To facilitate the rendering and processing of content items displayed on a resource 105, publishers 104 often place one or more publisher tags on the resource 105 (e.g., append the publisher tag to the HTML of the resource 105). A publisher tag is an instruction set or script specific to a particular service providing or eligible to provide a content item for display on the resource 105 (e.g., the content management and delivery system 110). The instruction set of a publisher tag includes instructions that are executed by user devices 106, when rendering the resource 105, for example, to ensure that content items from the particular service are properly rendered on the resource 105. The publisher tag, for example, can be provided to the publisher 104 by a content item/service provider (e.g., the content management and delivery system 110) when the publisher joins the content item provider's network of publishers 104.

A user device 106 is an electronic device that is under control of a user and is capable of requesting and receiving resources 105 over the network 102. Example user devices 106 include personal computers, televisions with one or more processors embedded therein or coupled thereto, set top boxes, mobile communication devices (e.g., smartphones), tablet computers, e-readers, laptop computers, personal digital assistants (PDA), and other devices that can send and receive data over the network 102. A user device 106 typically includes one or more user applications, such as a web browser, to facilitate the sending and receiving of data over the network 102.

A user device 106 can request resources 105 from a publisher 104. In turn, data representing the resource 105 can be provided to the user device 106 for presentation by the user device 106. The data representing the resource 105 can also include data specifying a portion of the resource 105 or a portion of a user device display in which content can be presented. These specified portions of the resource 105 or user device display are referred to as content item display environments (e.g., content item slots, or, in the case of advertisement content items, advertisement slots).

When a resource 105 is requested by a user device 106 and the resource 105 includes a content item display environment in which a content item of a content sponsor 108 is to be placed, the content management and delivery system 110 receives a request for a content item (e.g., from the user device 106 or the server hosting the requested resource 105).

In some implementations, the content management and delivery system 110 includes a request handler that can receive the content item request from a user device 106. The content management and delivery system 110 can, for example, use a selection process to select the content items (e.g., auction or reservation) from a content item data store 132 storing numerous indexed content items (e.g., indexed by content sponsor, subject matter, keywords). Selection of the content items can be based on various criteria, such as, for example, interest profiles, the relevance of content items to content on the resource 105, to a time of the day, geographical location, and keywords to name a few examples. The content management and delivery system 110, in turn, provides data specifying the selected content item(s) to the requesting user device 106 for display with the rendered resource 105.

For situations in which the systems discussed herein collect personal information about users, the users may be provided with an opportunity to opt in/out of programs or features that may collect personal information (e.g., information about a user's social network, social actions or activities, profession, a user's preferences, or a user's current location). In addition, certain data may be anonymized in one or more ways before it is stored or used, so that personally identifiable information is removed or obfuscated. In some implementations, users can opt out of being characterized for content, including advertisements, based on the interest profiles for which they may be characterized.

When a content item is provided by the content management and delivery system 110 and placed on a resource 105 an impression occurs. However, for the reasons described above, it can also be desirable to determine the exposure level of the user to the content item and/or determine whether the impression is a qualifying impression. In some implementations, to facilitate the determination of qualifying impressions and user exposure levels, the content management and delivery system 110 provides or otherwise makes available measurement instructions (e.g., stored in measurement data store 130) to user devices 106, as described below.

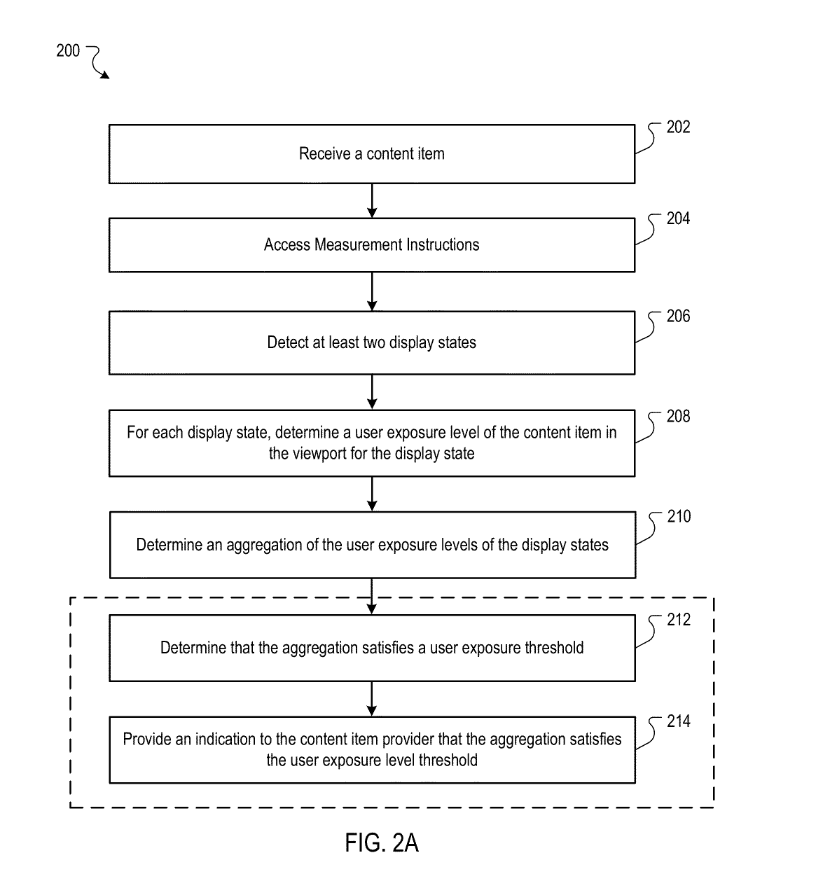

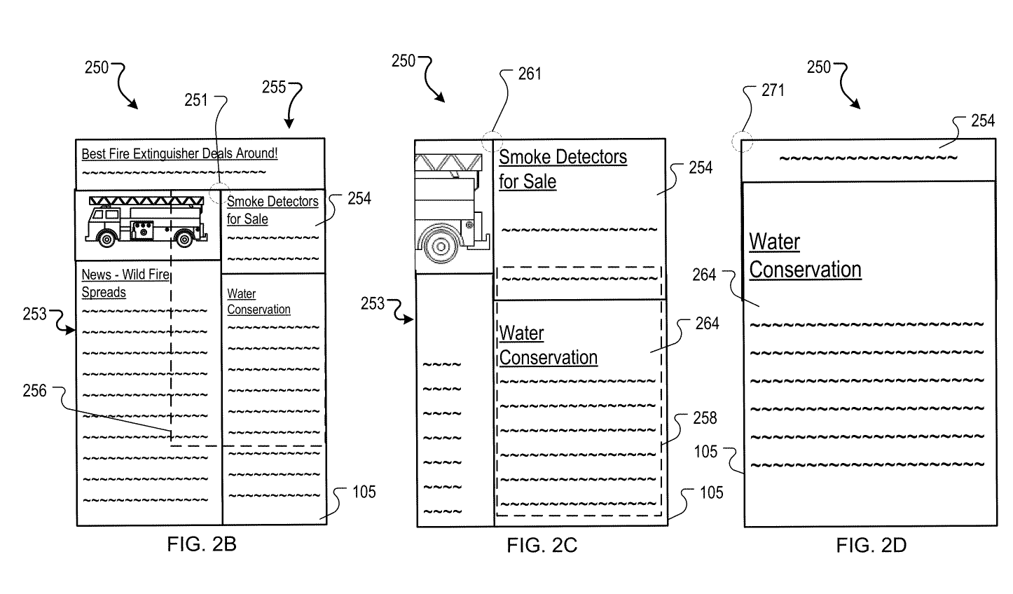

FIG. 2A is a flow diagram of an example process 200 for determining user exposure levels to content items. The process 200 can be implemented by a user device 106.

The process 200 receives a content item from a content item provider (202). For example, a user device 106 submits a content item request to the content management and delivery system 110 for a content item (e.g., advertisement) to place on a resource 105 (e.g., web page) rendered or being rendered by the user device 106. In turn, the content management and delivery system 110 selects a content item (or multiple content items depending on the parameters of the content item request) and provides the selected content item(s) to the requesting user device 106.

The process 200 accesses measurement instructions from the content provider (204). For example, during the process of rendering the resource 105, on which the requested content item(s) will be placed, the user device 106 executes a publisher tag in the HTML of the resource 105 for the specific content item provider to which the content item request was sent (e.g., the content management and delivery system 110).

The publisher tag causes the user device 106 to request the measurement instructions from, for example, the content management and delivery system 110 or otherwise access the measurement instructions. For example, if the user device 106 has not previously requested the measurement instructions and, therefore, does not have the measurement instructions locally stored (e.g., in the cache of a browser application), the publisher tag causes the user device 106 to request the measurement instructions from the content management and delivery system 110. The publisher tag can, for example, include a pointer (e.g., a URL address) to the measurement instructions hosted on a server of the content management and delivery system 110. The pointer is used by the user device 106 (e.g., by directing a browser application on the user device 106) to, for example, request the measurement instructions from the content management and delivery system 110.

Similarly, in some implementations, even if the user device 106 does have the measurement instructions locally stored, if the measurement instructions are determined to be stale (e.g., requested and received more than X days or weeks ago), the publisher tag causes the user device 106 to again request the measurement instructions from the content management and delivery system 110. In this way the user device 106 can obtain the most recent version of the measurement instructions (which may or may not different from the locally stored version of the measurement instructions). If the newly requested version is more recent then the publisher tag causes the user device 106 to replace the older version with the newer version.

Further, if the user device 106 does have the measurement instructions stored locally (e.g., and the instructions are not stale), the publisher tag causes the user device 106 to access the locally stored measurement instructions, rather than requesting the measurement instructions from the content management and delivery system 110. Once the user device 106 has accessed/received the measurement instructions, in some implementations, the instructions are executed by the user device 106 in the context of the resource 105 (e.g., as the user device 106 executes the instructions in the HTML of the resource 105). In some implementations, the functionality of the measuring instructions can be implemented, for example, in a browser extension, a plugin or a standalone application resident on the user device 106.

Regardless of how the measurement instructions are obtained or implemented, the measurement instructions include instructions (e.g., a script) that cause the user device 106 to measure user exposure levels to the content item during various display states of the viewport of the user device 106. As described below, a user exposure level represents a magnitude or level of the exposure (e.g., visual exposure) of the content in the viewport at a particular display state to the user and can be used as a proxy to gauge the engagement of the user to the content item at that display state.

A display state is a representation of a particular portion of the viewport or area of the viewport occupied by at least a portion of the content item. Thus a viewport can have numerous display states corresponding to different arrangements and positionings of the content item in the viewport. Display states are further described with reference to FIGS. 2B-2D, which are screen shots 250 of an example resource 105 displayed in a viewport having first, second and third display states, respectively.

FIG. 2B depicts a screen shot 250 of a resource 105 with various content including content item 254 displayed in a first display state of the viewport of a user device 106. As described above, a display state of a viewport represents a particular portion of the viewport or area of the viewport occupied by a content item of interest (or the portion of the content item that is displayed in the viewport as the resource 105 may be positioned in the viewport such that only a portion, and not all, of the content item is displayed in the viewport).

By way of an example, a first display state of the viewport is depicted in FIG. 2B. The first display state represents that the content item 254 occupies an area in the viewport, for example, defined by an origin at the upper left corner of the content item 254, as indicted by the phantom circle 251, at an offset of X1 units in the x-direction (e.g., left to right) from the left-hand border of the viewport 253 and Y1 units in the y-direction (e.g., top to bottom) from the top border of the viewport 255, and having a width in the x-direction of X2 units and a height in the y-direction of Y2 units. Thus the first display state of the viewport for the content item 254 represents that area/portion of the viewport defined by the rectangle with a top-left corner at the origin 251 extending to the right by X2 units and down by Y2 units. As such, the first display state represents that the area of the viewport occupied by the content item 254 is X2*Y2 units squared (e.g., inches squared, centimeters squared, pixels squared).

A second display state of the viewport is depicted in FIG. 2C. For example, the second display state occurs in response to a user causing the user device 106 to “zoom-in” to the region defined by the boundary 256 shown in FIG. 2B (e.g., to read the content item 254). The second display state represents that the content item 254 occupies an area in the viewport defined by an origin at the upper left corner of the content item 254, as indicted by the phantom circle 261, at an offset of X3 units in the x-direction from the left-hand border of the viewport 253, and having a width in the x-direction of X4 units and a height in the y-direction of Y4 units. There is no offset in the y-direction as the top of the content item 254 is coextensive with the top border of the viewport. Thus the second display state of the viewport for the content item 254 represents that area/portion of the viewport defined by the rectangle with a top-left corner at the origin 261 extending to the right by X4 units and down by Y4 units. As such, the second display state represents that the area of the viewport occupied by the content item 254 is X4*Y4 units squared.

Given that the screen shot depicted in FIG. 2C is zoomed-in on the content item 254, as compared with that shown in the screen shot depicted in FIG. 2B, the area of the viewport occupied by the content item 254 in FIG. 2C is greater than the area of the viewport occupied by the content item 254 in FIG. 2B. In other words, the area defined by X4*Y4 is greater than the area defined by X2*Y2.

A third display state of the viewport is depicted in FIG. 2D. For example, the third display state occurs in response to a user causing the user device 106 to “zoom-in” to the region defined by the boundary 258 shown in FIG. 2C (e.g., to read the content 264). Such zooming causes only the bottom portion of the content item 254 to be displayed in the viewport as depicted in FIG. 2D. Thus display states can represent that the entire content item is displayed in the viewport or that only a portion (e.g., less than all) of the content item is displayed in the viewport.

The third display state represents that the content item 254 occupies an area in the viewport defined by an origin at the upper left corner of the visible/displayed portion of the content item 254, which is also the upper left corner of the viewport, as indicted by the phantom circle 271 (there is no offset in the x- or y-directions), and having a width in the x-direction of X5 units (the same as the width of the viewport) and a height in the y-direction of Y5 units. Thus the third display state of the viewport for the content item 254 represents that area/portion of the viewport defined by the rectangle with a top-left corner at the origin 271 extending to the right by X5 units and down by Y5 units. As such, the third display state represents that the area of the viewport occupied by the content item 254 is X5*Y5 units squared.

Given that the screen shot depicted in FIG. 2D is zoomed-in on the content 264 and only displays a small portion of the content item 254, as compared with that shown in the screen shot depicted in FIG. 2C, the area of the viewport occupied by the content item 254 in FIG. 2D is less than the area of the viewport occupied by the content item 254 in FIG. 2C even though the zoom level of the viewport in FIG. 2D is higher. In other words, the area defined by X5*Y5 is less than the area defined by X4*Y4.

In some implementations, a display state represents the area of the viewport occupied by the content item and also the relative position of the content item in the viewport (e.g., the offset of the content item). However, in other implementations, a display state represents the area of the viewport occupied by the content item without specifying the relative position of the content item in the viewport. Further, a viewport can have a display state for each content item on the resource 105 displayed in the viewport. For example, if a resource 105 included two different content items and both content items were displayed (or at least partially displayed) in the viewport at the same time or different times, then there would be at least one display state for the viewport for the first content item and at least one second, separate display state for the viewport for the second content item. Thus for a given resource view event there can be multiple display states for each of multiple different content items placed on the resource 105 and the process 200 can be performed for each content item.

The process 200 detects at least two display states (206). In some implementations, the measurement instructions cause the user device 106 to monitor the display of the resource 105 in the viewport during the resource view event to identify and log numerous display states (e.g., in a browser application's cache). A resource view event for a resource defines the viewing event starting upon an initial display of at least a portion of the resource in a viewport and ending with the resource (or any portion thereof) no longer being displayed in the viewport (e.g., the browser application is closed or instructed to navigate to another resource). For example, during the resource view event shown in the sequence of screen shots depicted in FIGS. 2B-2D, the measurement instructions cause the user device 106 to detect the first display state depicted in FIG. 2B, the second display state depicted in FIG. 2C (e.g., after the first zoom event) and the third display state depicted in FIG. 2D (e.g., after the second zoom event).

In some implementations, the measurement instructions cause the user device 106 to detect display states by accessing and using one or more application programming interfaces (API) from the browser application operating on the user device 106 and through which the user device 106 renders and displays the resource 105. More particularly, the measurement instructions can cause the user device 106 to use browser application APIs to determine, at particular times during the resource view event, which portion of the resource 105 is currently displayed in the viewport and to determine the relative location of the content item on the resource 105 (e.g., where the content item is placed on the resource 105).

Once the region defining the portion of the resource 105 currently displayed in the viewport and the region defining the relative location of the content item on the resource 105 are known, the measurement instructions cause the user device 106 to determine if there is any overlap between the regions (e.g., an intersection between the regions). An overlap indicates that some portion of the content item occupies the viewport. The extent of the overlap indicates the area/portion of the viewport occupied by the content item. This process can be repeated on a periodic basis (e.g., every second) or in response to a user causing the user device 106 to change the current display of the resource 105 (e.g., zooming or panning), or some combination thereof. In this way the measurement instructions can cause the user device 106 to detect display states of the viewport (e.g., during a resource view event).

By way of an example, assuming that the resource 105 is shown in its entirety in the screenshot depicted in FIG. 2B, the measurement instructions can cause the user device 106 to query to the browser application to determine what portion of the resource 105 is being displayed in the viewport to determine that all of the resource 105 is currently displayed in the viewport. Thus if the resource 105 has a height of 400 pixels (e.g., in the y-direction) and a width of 200 pixels (e.g., in the x-direction), then the query response, for example, would specify that the coordinates of the portion of the resource 105 displayed in the viewport are (0, 0) to (200, 400). The measurement instructions can also cause the user device 106 to query to the browser application to determine the relative position of the content item 254 on the resource 105. The response to such a query, for example, would specify that the coordinates of the content item 254 on the resource 105, with reference to FIG. 2B, are (110, 50) to (200, 105).

Given the region defining the portion of the resource 105 currently displayed in the viewport and the region defining the relative location of the content item 254 on the resource 105 are now known, the measurement instructions cause the user device 106 to detect the display state (e.g., determine if there is overlap and, if so, to what extent). For example, the measurement instructions cause the user device 106 to detect the first display state depicted in FIG. 2B, which represents that, as there is complete overlap between the regions defining content item 254 and the resource 105 in the viewport, the area of the viewport occupied by the content item 254 is 90 pixels (i.e., 200−110)×55 pixels (i.e., 105-50) or, equivalently, 4,950 pixels squared or 3.45 centimeters squared.

In a similar manner, the measurement instructions cause the user device 106 to detect the second and third display states depicted in FIGS. 2C and 2D, which represent that the respective areas of the viewport occupied by the content item 254 are, for example, 11,500 pixels squared/8.06 centimeters squared and 5,300 pixels squared/3.7 centimeters squared.

The process 200 determines, for each detected display state, a user exposure level of the content item in the viewport for the display state (208). For example, the measurement instructions cause the user device 106 to determine a user exposure level for each detected display state or some subset of specified display states. The user exposure level is a measurement of an area of the particular portion of the viewport (e.g., eight centimeters squared, 400 pixels squared) occupied by the content item or a portion thereof for the display state and the time duration of the display state (e.g., the length of time the display state persists).

In some implementations, the user exposure level for a display state is the product of the area of the portion of the viewport occupied by the content item in the display state and the duration of the display state. As described above, the user exposure level can be used as a proxy to determine the level of user engagement to the content item (e.g., for the display state). For example, a first content item that occupies eighty percent of a viewport for fifteen seconds is more likely “seen” by a user than a second content item that occupies twenty percent of a viewport for three seconds on the same user device. As, in some implementations, the user exposure level is a function of the product of the area of the viewport occupied by the content item and the duration of the display state, a comparison of the user exposure levels to the first and second content items indicate that the user is more likely engaged to the first content item than the second content item (e.g., as the exposure level for the display state with the first content item is greater than the exposure level for the display state with the second content item).

As described above, the measurement instructions can cause the user device 106 to determine the area of the viewport occupied by a content item for a display state based on a comparison of the overlap between the regions defining the portion of the resource 105 currently displayed in the viewport and the region defining the location of the content item 254 on the resource 105. The measurement instructions can also cause the user device 106 to determine the duration of a display state. For example, in some implementations, the measurement instructions cause the user device 106 to initiate a timer upon detection of each display state and maintain the timer until the display state ends, for example, because another display state starts or the resource view event ends (e.g., the browser is closed or instructed to navigate to another resource). The measurement instructions cause the user device 106 to “read” the timer for the display state to determine the time duration of the display state (e.g., how long the display state lasts). For example, with reference to the first display state depicted in FIG. 2B, the second display state depicted in FIG. 2C and the third display state depicted in FIG. 2D, the durations are three seconds, ten seconds and eight seconds, respectively.

In some implementations, rather than initiating a timer upon the detection of a display state, the measurement instructions cause the user device to “read” the time the display state is detected and the time the display state ended off of a system clock (e.g., the user device 106 system clock) to determine the duration of the display state.

As described above, regardless of how the area of the viewport occupied by a content item for a display state and the duration of the display state are determined, the measurement instructions can cause the user device 106 to determine the user exposure level for the display state based on a function of the area and duration (e.g., a product of the area and duration). For example, the measurement instructions cause the user device 106 to determine that the user exposure levels for the first, second and third displays states depicted in FIGS. 2B, 2C and 2D, respectively, are 10.35 centimeter squared-seconds (3.45 centimeters squared*3 seconds), 80.6 centimeter squared-seconds (8.06 centimeters squared*10 seconds) and 29.6 centimeter squared-seconds (3.7 centimeters squared*8 seconds).

In some implementations, user exposure levels for display states can be weighted. For example, user exposure levels for display states for which an area of the viewport occupied by a content item exceeds fifty percent of the total area (or some other threshold) of the viewport and/or for which the duration exceeds a duration threshold can be weighted by a factor greater than one. Such weighting increases the user exposure level to indicate that the content item was likely seen by a user given the extent or duration with which it occupied the viewport. Likewise, user exposure levels for display states for which an area of the viewport occupied by a content item does not exceed fifty percent of the total area (or some other threshold) of the viewport and/or for which the duration dos not exceed a duration threshold can be weighted by a factor less than one. Such weighting decreases the user exposure level to indicate that the content item was less likely seen by a user as compared to those exposure levels for display states with areas/durations that do exceed the relevant thresholds.

Further, in some implementations, more recent display states are weighted more than less recent display states. For example, if two display states occur during a resource view event, then the user exposure level for the most recently occurring of the two display states is weighted more than the user exposure level for the first occurring of the two display states.

In some implementations, the measurement instructions only cause the user device 106 to determine a user exposure level for a particular display state if the area of the viewport occupied by the content item for the display state satisfies a viewport area threshold (e.g., ten percent of the total area of the viewport). For example, in response to determining that the area of the viewport occupied by a content item (e.g., as determined in the process 206) is less than ten percent of the total area of the viewport then the user device 106 will be instructed not to determine a user exposure level for that display state, which can save system resources.

In some implementations, the measurement instructions only cause the user device 106 to determine a user exposure level for a particular display state if the zoom level for the viewport satisfies a zoom level threshold. For example, the zoom level threshold can be set such that a user exposure level is determined only if the zoom level is likely to result in the content item (or a minimum displayed portion thereof) being discernable at the zoom level (e.g., legible to the user). A zoom level likely to result in the content being discernable at the zoom level is, for example, a zoom level that causes the content (e.g., words) of the content item to be a specified minimum size. Such a zoom level threshold can be used to prevent a user exposure level from being determined or included in the aggregation of user exposure levels (and a content item sponsor potentially being charged for an impression) when the zoom level is such that the content item (or a minimum displayed portion thereof) is not readily discernable or legible to the user.

The process 200 determines an aggregation of the user exposure levels of the display states (210). In some implementations, the measurement instructions cause the user device 106 to aggregate the user exposure levels of the display states for a content item during a resource view event to generate an aggregated user exposure level to the content item during various display states of the resource view event (e.g., which may include any number of display states). As users may cause user devices to zoom in and out and pan around to view various portions of a resource 105 (including content items), aggregating the exposure levels for the display states (each of which corresponds to a particular view of the content item in the viewport), allows the exposure to the content item to be determined across the entire resource view event, as compared to the exposure at any given one display state. As described above, such a macro level view can permit a more comprehensive understanding of user exposure to the content item.

In some implementations, if the time period between display states of a content item during a resource view event exceed a threshold time (e.g., thirty seconds), the measurement instructions will prevent the user device 106 from aggregating the user exposure levels for display states occurring before the start of the time period with those occurring after the end of the time period. For example, if two display states for a content item occur before a time period that exceeds the specified threshold and two display states for the content item occur after the time period, then the user exposure levels for the two display states occurring before the time period will not be aggregated with the user exposure levels for the two display states occurring after the time period.

With reference to the first, second and third display states depicted in FIGS. 2B, 2C and 2D, respectively, which occur during the same resource view event, the measurement instructions cause the user device 106 to aggregate the user exposure levels for each of the first, second and third display states to determine that the aggregated user exposure level is 120.55 centimeter squared-seconds (10.35 centimeter squared-seconds+80.6 centimeter squared-seconds+29.6 centimeter squared-seconds). Thus, in some implementations, the aggregated user exposure level for display states that occur during a resource view event is the sum of the user exposure levels for the display states that occur during the resource view event. If the user exposure levels are weighted, as described above, then the aggregated user exposure level is the sum of the weighted user exposure levels.

The process 200 determines that the aggregation satisfies a user exposure level threshold (212). For example, the measurement instructions cause the user device 106 to compare the aggregated user exposure level to a user exposure level threshold to determine whether the aggregated user exposure level satisfies the threshold. In some implementations, the user exposure level threshold is set by the content sponsor of the content item (such that each content item could have a different user exposure level threshold), set by the publisher of the resource 105 or globally set for all content items by the engagement determination system 120. For example, if the user exposure level threshold is 110 centimeter squared-seconds, the measurement instructions cause the user device 106 to compare the aggregated user exposure level from the first, second and third display states (120.55 centimeter squared-seconds) to the user exposure level threshold to determine that the aggregated user exposure level satisfies (e.g., exceeds) the user exposure level threshold.

In some implementations, in the case that the content sponsor sets the user exposure level threshold on a per-content item basis, the content management and delivery system 110 can append data specifying the threshold to the data specifying the content item provided to the user device in the process 202. In turn, the measurement instructions can cause the user device 106 to use the content sponsor specified threshold, if one has been provided with the content item. In some implementations, rather than including data specifying the threshold with the content item, the measurement instructions include the data specifying the threshold (e.g., content sponsor specific or otherwise).

The process 200 provides an indication to the content item provider that the aggregation satisfies the user exposure level threshold (214). For example, in response to determining that the aggregated user exposure level satisfies the user exposure level threshold, the measurement instructions cause the user device 106 to send to the engagement determination system 120 data indicating that the aggregated user exposure level to the content item satisfies the user exposure level threshold. The engagement determination system 120 can use the indication to charge the content sponsor of the content item for a qualifying impression or record that a qualifying impression has occurred.

Although the process 200 is described with reference to display states occurring during a resource view event, in some implementations, the exposure levels to a particular content item can be consolidated for display states across multiple resource view events occurring within a specified time period, aggregated and compared to a user exposure level threshold. For example, display state A may occur upon a user device 106 initially rendering a first resource 105 and the viewport displaying a content item. The user may then cause the user device 106 to navigate away from the first resource 105 to a second resource 105 (e.g., the user causes a link on the first resource 105 to the second resource 105 to be selected) thereby ending the initial resource view event for the first resource 105.

However, if the user causes the user device 106 to navigate back to the first resource 105 (e.g., causes the selection of the “back” button) a subsequent resource view event for the first resource 105 occurs. If a display state B occurs (for the same content item) during the subsequent resource view event, and within a specified time period of the initial resource view event, the measurement instruction cause the user device 106 to consolidate the two resource view events for the first resource 105. The measurement instruction further cause the user device 106 to aggregate the user exposure levels for each display state (e.g., display state A and B) for the content item occurring in the initial resource view event and the subsequent resource view event for the first resource 105. The process 200 can continue, as described above, based on the aggregated user exposure level determined across the two resource view events for the first resource 105.

In some implementations, in addition or alternative to providing the indication to the engagement determination system 120, the measurement instructions cause the user device 106 to provide data specifying the display states and display state durations to the engagement determination system 120, which the engagement determination system 120 can use to determine qualifying impressions or otherwise analyze the performance of the content item and user exposure/engagement to the content item.

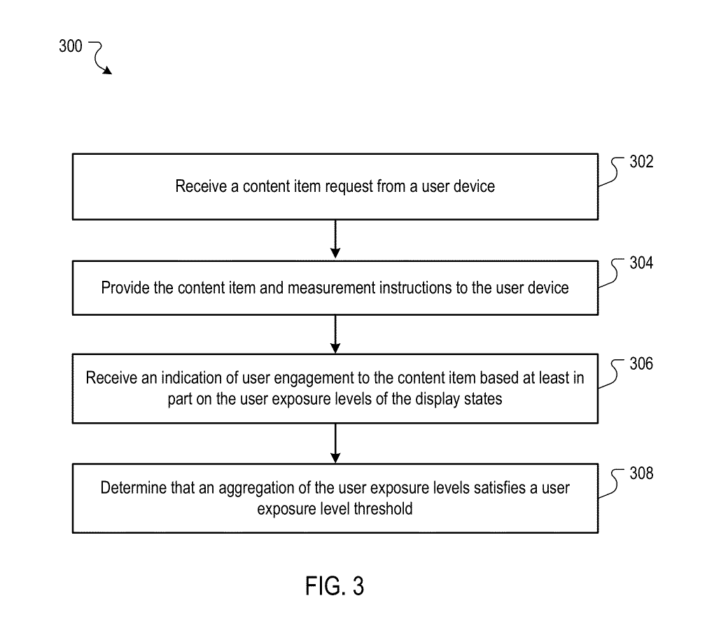

FIG. 3 is a flow diagram of an example process 300 for receiving an indication that a user exposure level to content item satisfies a threshold. The process 300 receives a content item request from a user device for a content item to be presented with a resource displayed by the user device (302). For example, the content management and delivery system 110 receives a content item request from a user device 106 for a content item to display with a resource 105.

The process 300 provides the content item and measurement instructions to the user device (304). For example, the content management and delivery system 110 provides the content item to the user device in response to the content item request and the engagement determination system 120 subsequently or concurrently provides the measurement instructions to the user device 106 in response to the same request or a separate request for the measurement instructions. As described above, the measurement instructions cause the user device 106 to provide indications of whether aggregated user exposure levels for various content items satisfy the applicable user exposure level thresholds.

The process 300 receives an indication of user engagement to the content item based at least in part on the user exposure levels of the display states (306). In some implementations, the engagement determination system 120 receives the indication from the user device 106. The indication can be, for example, an indication that an aggregation of the user exposure levels satisfies the user exposure level threshold or an indication specifying the individual user exposure levels (e.g., but does not specify an aggregation of the user exposure levels or whether an aggregation of the user exposure levels satisfies a given threshold).

The process 300 determines that an aggregation of the user exposure levels satisfies a user exposure level threshold based on the indication (308). In some implementations, the engagement determination system 120 can determine that an aggregation of the user exposure levels satisfies the user exposure level threshold, determine that a qualifying impression occurred and charge the relevant sponsor for the qualifying impression. For example, the engagement determination system 120 directly determines (e.g., without having to first aggregate user exposure levels) that the aggregation satisfies the user exposure level threshold if the indication from the user device 106 includes an explicit indication that the threshold was exceeded (e.g., as the user device 106 aggregated the user exposure levels and then compared the aggregation with the user exposure level threshold). If the indication does not include such an explicit indication but rather specifies the various user exposure levels, the engagement determination system 120 aggregates the user exposure levels and determines whether the aggregation satisfies the user exposure level threshold.

Although the above description has focused on determining exposure levels and user engagement to content items such as advertisements, the techniques described herein are equally applicable to determining user exposure/engagement to any type of content on a resource.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. A computer storage medium is not a propagated signal and does not include transitory signals. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

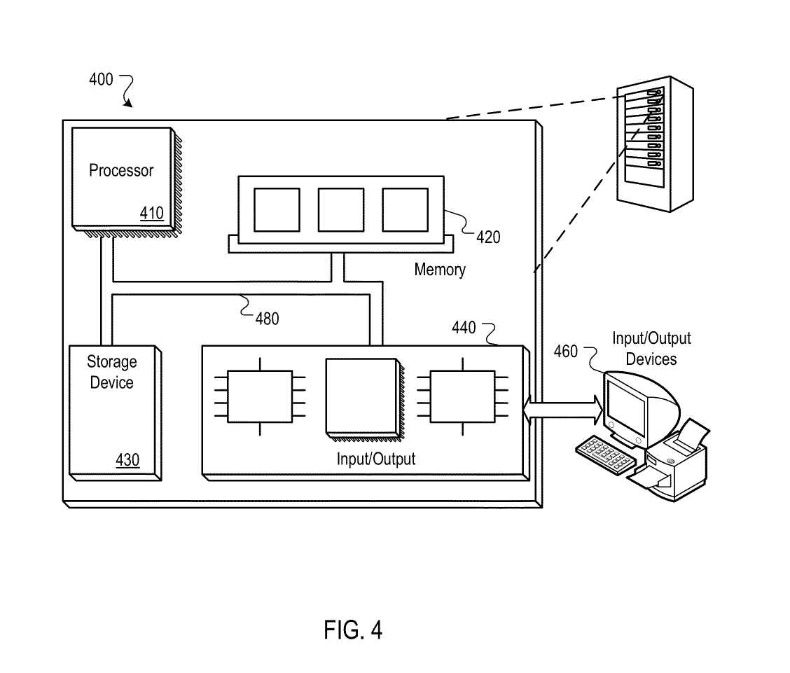

An example of one such type of computer is shown in FIG. 4, which shows a block diagram of a programmable processing system (system). The system 400 that can be utilized to implement the systems and methods described herein. The architecture of the system 400 can, for example, be used to implement a computer client, a computer server, or some other computer device.

The system 400 includes a processor 410, a memory 420, a storage device 430, and an input/output device 440. Each of the components 410, 420, 430, and 440 can, for example, be interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 300. In one implementation, the storage device 430 is a computer-readable medium. In various different implementations, the storage device 430 can, for example, include a hard disk device, an optical disk device, or some other large capacity storage device.

The input/output device 440 provides input/output operations for the system 400. In one implementation, the input/output device 440 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 460.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by a user device, a content item from a content item provider;
accessing, by the user device, measurement instructions from the content provider including instructions to measure user exposure levels to the content item during various display states of a viewport of the user device, each of the display states representing a particular portion of the viewport occupied by at least a portion of the content item, wherein the particular portion of each display state is different from the particular portion of each other display state, and upon execution of the measurement instructions by the user device:
detecting, by the user device, at least two display states;
for each of the display states, determining, by the user device, a user exposure level of the content item in the viewport for the display state, the user exposure level being a measurement of (i) an area of the particular portion of the viewport occupied by the at least a portion of the content item for the display state and (ii) a duration of the display state; and
determining, by the user device, an aggregation of the user exposure levels of the display states.

2. The method of claim 1, further comprising:
determining, by the user device, that the aggregation satisfies a user exposure level threshold; and
providing, by the user device, an indication to the content item provider that the aggregation satisfies the user exposure level threshold.

3. The method of claim 2, wherein the user exposure level threshold is specified by a sponsor of the content item.

4. The method of claim 1, further comprising determining, by the user device, that the area of the particular portion of the viewport occupied by the at least a portion of the content item satisfies a viewport area threshold; and
wherein determining the user exposure level comprises determining the user exposure level only in response to determining that the area of the particular portion of the viewport occupied by the at least a portion of the content item satisfies the viewport area threshold.

5. The method of claim 1, wherein determining the user exposure level comprises:
determining a product of the area of the particular portion of the viewport occupied by the at least a portion of the content item in the display state and the duration of the display state.

6. The method of claim 5, wherein determining the aggregation of the user exposure levels comprises determining a sum of the products.

7. The method of claim 1, wherein accessing measurement instructions from the content provider comprises requesting the measurement instructions from a server apparatus hosted by the content provider.

8. The method of claim 1, further comprising:
providing the user exposure levels to the content item provider.

9. A method comprising:
receiving a content item request from a user device for a content item to be presented with a resource displayed by the user device;
providing the content item and measurement instructions to the user device, wherein the measurement instructions, upon execution by the user device, cause the user device to:
for each of a plurality of display states of a viewport of the user device, determine a user exposure level to the content item during the display state, wherein the display state represents a particular portion of the viewport occupied by at least a portion of the content item, the particular portion of each display state being different from the particular portion of each other display state, and wherein the user exposure level is a measurement of (i) an area of the particular portion of the viewport occupied by the at least a portion of the content item for the display state and (ii) a duration of the display state;
receiving, from the user device, an indication of user engagement to the content item based at least in part on the user exposure levels of the display states; and
determining that an aggregation of the user exposure levels satisfies a user exposure level threshold based at least in part on the indication.

10. The method of claim 9, wherein:
the measurement instructions, upon execution by the user device, cause the user device to determine the aggregation of the user exposure levels and determine whether the aggregation satisfies the user exposure level threshold; and
receiving the indication comprises receiving an indication that the aggregation satisfies the user exposure level threshold.

11. The method of claim 9, wherein:
receiving the indication comprises receiving the user exposure levels from the user device; and
determining that the aggregation of the user exposure levels satisfies the user exposure level threshold comprises aggregating the user exposure levels.

12. A system comprising:
one or more data processors; and
instructions stored on a computer storage apparatus that when executed by the one or more data processors cause the one or more data processors to perform operations comprising:
receiving, by a user device, a content item from a content item provider;
accessing, by the user device, measurement instructions from the content provider including instructions to measure user exposure levels to the content item during various display states of a viewport of the user device, each of the display states representing a particular portion of the viewport occupied by at least a portion of the content item, wherein the particular portion of each display state is different from the particular portion of each other display state, and upon execution of the measurement instructions by the user device:
detecting, by the user device, at least two display states;
for each of the display states, determining, by the user device, a user exposure level of the content item in the viewport for the display state, the user exposure level being a measurement of (i) an area of the particular portion of the viewport occupied by the at least a portion of the content item for the display state and (ii) a duration of the display state; and
determining, by the user device, an aggregation of the user exposure levels of the display states.

13. The system of claim 12, wherein the instructions, when executed by the one or more data processors, cause the one or more data processors to perform further operations comprising:
determining, by the user device, that the aggregation satisfies a user exposure level threshold; and
providing, by the user device, an indication to the content item provider that the aggregation satisfies the user exposure level threshold.

14. The system of claim 13, wherein the user exposure level threshold is specified by a sponsor of the content item.

15. The system of claim 12, wherein the instructions, when executed by the one or more data processors, cause the one or more data processors to perform further operations comprising determining, by the user device, that the area of the particular portion of the viewport occupied by the at least a portion of the content item satisfies a viewport area threshold; and
wherein determining the user exposure level comprises determining the user exposure level only in response to determining that the area of the particular portion of the viewport occupied by the at least a portion of the content item satisfies the viewport area threshold.

16. The system of claim 12, determining the user exposure level comprises:
determining a product of the area of the particular portion of the viewport occupied by the at least a portion of the content item in the display state and the duration of the display state.

17. The system of claim 16, wherein determining the aggregation of the user exposure levels comprises determining a sum of the products.

18. The system of claim 12, wherein accessing measurement instructions from the content provider comprises requesting the measurement instructions from a server apparatus hosted by the content provider.

19. The system of claim 12, wherein the instructions, when executed by the one or more data processors, cause the one or more data processors to perform further operations comprising providing the user exposure levels to the content item provider.

20. A computer-readable storage medium having instructions stored thereon, which, when executed by one or more data processors, cause the one or more processor to perform operations comprising:
receiving, by a user device, a content item from a content item provider;
accessing, by the user device, measurement instructions from the content provider including instructions to measure user exposure levels to the content item during various display states of a viewport of the user device, each of the display states representing a particular portion of the viewport occupied by at least a portion of the content item, wherein the particular portion of each display state is different from the particular portion of each other display state, and upon execution of the measurement instructions by the user device:
detecting, by the user device, at least two display states;
for each of the display states, determining, by the user device, a user exposure level of the content item in the viewport for the display state, the user exposure level being a measurement of (i) an area of the particular portion of the viewport occupied by the at least a portion of the content item for the display state and (ii) a duration of the display state; and
determining, by the user device, an aggregation of the user exposure levels of the display states.
